(19) United States
(12) Patent Application Publication
(10) Pub. No.: US 2004/0167348 A1
(43) Pub. Date: Aug. 26, 2004

(54) Methods for purifying O,O-dialkyl S-[2-(alkylthio)alkyl] phosphorodithioates

(76) Inventors: Vidyanatha A. Prasad, Leawood, KS (US); Robert D. Ingalls, Portage, MI (US); Stephen C. Slahck, Independence, MO (US); Christopher M. Tusa, Raymore, MO (US); Paul E. Nagy, Meerbusch (DE); Michael P. Newcomer, Kansas City, MO (US); Donald K. Smith, Liberty, MO (US)

Correspondence Address: BAYER CROPSCIENCE LP, Patent Department, 100 BAYER ROAD, PITTSBURGH, PA, 15205-9741, US

(21) Appl. No.: 10/374,459

(22) Filed: Feb. 26, 2003

(51) Int. Cl. C07F 9/02

(52) U.S. Cl. 558/146

(57) ABSTRACT

The invention relates to a method of purifying an O,O-dialkyl S-[2-(alkylthio)alkyl] phosphorodithioate by purging a sample containing a volatile and the O,O-dialkyl S-[2-(alkylthio)alkyl] phosphorodithioate with a gas.

### BACKGROUND OF THE INVENTION

The invention relates to methods for purifying O,O-dialkyl S-[2-(alkylthio)alkyl] phosphorodithioates. More particularly, the invention relates to methods of purifying an O,O-dialkyl S-[2-(alkylthio)alkyl] phosphorodithioate that include the step of purging a sample comprising a volatile, particularly an odorous volatile, and the O,O-dialkyl S-[2-(alkylthio)alkyl] phosphorodithioate with a gas.

O,O-dialkyl S-[2-(alkylthio)alkyl] phosphorodithioates, such as O,O-diethyl S-[2-(ethylthio)ethyl] phosphorodithioate, can be used as pesticides. The compounds are active against insect pests such as aphids, mites, leafhoppers, flea beetles, bean beetles, potato beetles, and thrips.

Unfortunately, O,O-dialkyl S-[2-(alkylthio)alkyl] phosphorodithioates often contain odorous volatiles which individuals handling or applying the O,O-dialkyl S-[2-(alkylthio)alkyl] phosphorodithioates find unpleasant.

U.S. Pat. No. 5,719,102 discloses a method for reducing odor in an odoriferous herbicide that includes the step of mixing a nonionic surfactant blend with an odoriferous herbicide.

U.S. Pat. RE33,670 discloses removing volatile compounds from methyl parathion-loaded Diatomite at about 500 and 130 mm Hg.

U.S. Pat. No. 5,292,863 discloses removing unpolymerized gaseous monomers from a solid olefin polymer using an inert gas purge.

A need exists for methods of purifying an O,O-dialkyl S-[2-(alkylthio)alkyl] phosphorodithioates. A need also exists for methods of reducing the level of odorous volatiles in O,O-dialkyl S-[2-(alkylthio)alkyl] phosphorodithioates.

Accordingly, it is an object of the present invention to obviate problems of the prior art. It is also an object of the present invention to provide methods of reducing the levels of odorous volatiles in samples of O,O-dialkyl S-[2-(alkylthio)alkyl] phosphorodithioates. It is also an object of the present invention to provide methods of purifying O,O-dialkyl S-[2-(alkylthio)alkyl] phosphorodithioates that do not require a vacuum treatment.

These and additional objects are provided by the methods of the invention.

### SUMMARY OF THE INVENTION

One aspect of the invention provides a method of purifying an O,O-dialkyl S-[2-(alkylthio)alkyl] phosphorodithioate comprising purging a sample comprising one or more volatiles (particularly an odorous volatile) and the O,O-dialkyl S-[2-(alkylthio)alkyl] phosphorodithioate with a gas.

Another aspect of the invention provides a method of reducing the level of volatiles in an O,O-dialkyl S-[2-(alkylthio)alkyl] phosphorodithioate having the formula

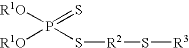

wherein

each R¹ is independently C₁-C₄ alkyl (preferably CH₃, C₂H₅, n-C₃H₇, or i-C₃H₇, more preferably C₂H₅),

R² is C₁-C₄ alkylene (preferably CH₂ or C₂H₄, more preferably C₂H₄), and

R³ is C₁-C₄ alkyl (preferably CH₃ or C₂H₅, more preferably C₂H₅),

comprising subjecting the O,O-dialkyl S-[2-(alkylthio)alkyl] phosphorodithioate to a gas purge.

Another aspect of the invention provides a method of reducing odor in a sample comprising an odorous volatile and an O,O-dialkyl S-[2-(alkylthio)alkyl] phosphorodithioate having the formula

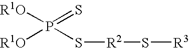

wherein

each R¹ is independently C₁-C₄ alkyl (preferably CH₃, C₂H₅, n-C₃H₇, or i-C₃H₇, more preferably C₂H₅),

R² is C₁-C₄ alkylene (preferably CH₂ or C₂H₄, more preferably C₂H₄), and

R³ is C₁-C₄ alkyl (preferably CH₃ or C₂H₅, more preferably C₂H₅),

comprising subjecting the sample to a gas purge.

### DETAILED DESCRIPTION OF THE INVENTION

These and additional aspects, objects, and advantages of the invention are more fully described in the following detailed description.

The present invention is directed to methods of purifying O,O-dialkyl S-[2-(alkylthio)alkyl] phosphorodithioates, preferably an O,O-dialkyl S-[2-(alkylthio)alkyl] phosphorodithioate having the formula

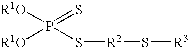

wherein

each R¹ is independently C₁-C₄ alkyl (preferably CH₃, C₂H₅, n-C₃H₇, or i-C₃H₇, more preferably C₂H₅),

R² is C₁-C₄ alkylene (preferably CH₂ or C₂H₄, more preferably C₂H₄), and

R³ is C₁-C₄ alkyl (preferably CH₃ or C₂H₅, more preferably C₂H₅).

A particularly preferred O,O-dialkyl S-[2-(alkylthio)alkyl] phosphorodithioate is O,O-diethyl S-[2-(ethylthio)ethyl] phosphorodithioate, which is also called phosphorodithioic acid O,O-diethyl S-[2-(ethylthio)ethyl] ester, O,O-diethyl S-ethylmercaptoethyl dithiophosphate, and disulfoton and is available under the name Di-Syston®.

The present invention is directed to a method of purifying O,O-dialkyl S-[2-(alkylthio)alkyl] phosphorodithioates by purging a sample containing odorous volatiles and the O,O-dialkyl S-[2-(alkylthio)alkyl] phosphorodithioates with a gas. Suitable gases include air and inert gases such as nitrogen or helium.

The step of purging an O,O-dialkyl S-[2-(alkylthio)alkyl] phosphorodithioate with a gas occurs for a time and at a purge rate sufficient to reduce the level of at least one odorous volatile in the sample. In one embodiment the purging occurs for a time in the range of from about 0.5 to about 6 hours, preferably from about 2 to about 4 hours, and at a rate in the range of from about 25 to about 100 liters per minute, preferably from about 50 to about 75 liters per minute.

The purge may be performed at any suitable temperature, such as from about 20° C. to about 40° C., preferably from about 20° C. to about 30° C. In one embodiment the purge is performed at room temperature. For example, a sample comprising odorous volatiles and the O,O-dialkyl S-[2-(alkylthio)alkyl] phosphorodithioates may purged with 50 liters per minute of nitrogen or air for 4 hours at room temperature.

In one embodiment of the invention the gas purging reduces the level of at least one volatile by-product or contaminant, such as sulfur dioxide, chloroethane, ethanethiol, ethyl vinyl sulfide or ethyl sulfide, from a sample of O,O-dialkyl S-[2-(alkylthio)alkyl] phosphorodithioates.

Preferably the level of chloroethane and/or ethanethiol is reduced. In one embodiment of the invention the level of chloroethane is reduced by at least 50% (preferably at least 60%) and the level of ethanethiol is similarly reduced by at least 50% (preferably at least 60%) compared to the levels prior to purging.

In various embodiments of the invention, after purging a sample containing O,O-dialkyl S-[2-(alkylthio)alkyl] phosphorodithioates, the sample may contain no more than about 20 ppm (preferably no more than about 10 ppm) of sulfur dioxide; no more than about 50 ppm (preferably no more than about 10 ppm) of chloroethane; no more than about 50 ppm (preferably no more than about 10 ppm) of ethanethiol; no more than about 20 ppm (preferably no more than about 5 ppm) of ethyl vinyl sulfide; or no more than about 15 ppm (preferably no more than about 10 ppm) of ethyl sulfide.

In other embodiments of the invention, after the purging, the level of chloroethane is reduced by at least 50% (preferably at least 60%); the level of ethanethiol is reduced by at least 50% (preferably at least 70%); the level of ethyl vinyl sulfide is reduced by at least 50% (preferably at least 60%); or the level of ethyl sulfide is reduced by at least 30% (preferably at least 40%) compared to the levels prior to purging.

Samples treated in accordance with the present invention are preferably not subjected to a vacuum treatment.

Throughout the examples and the present specification, parts and percentages are by weight unless otherwise specified. The following examples are illustrative only and are not intended to limit the scope of the methods of the invention as defined by the claims.

### EXAMPLE

Four samples of O,O-diethyl S-[2-(ethylthio)ethyl] phosphorodithioate were provided. One untreated sample served as a control. A second sample was treated by purging with about 1 liter per second of nitrogen for 4 hours at room temperature, while a third sample was purged with about 1 liter per second of air for 4 hours at room temperature. The fourth sample was subjected to a vacuum at 50 torr for 4 hours at 60° C.

The samples were evaluated for sulfur dioxide, chloroethane, ethanethiol, ethyl vinyl sulfide, and ethyl sulfide. The samples were evaluated by standard analytical techniques, including gas chromatography and HPLC. Assay results are shown in the following table.

TABLE

| Volatile | | Nitrogen | Air | |
|---|---|---|---|---|
| material | Untreated | purge | purge | Vacuum |
| sulfur dioxide | 10 | 8 | 10 | 8 |
| (ppm) | | | | |
| chloroethane | 33 | 5 | 6 | 100 |
| (ppm) | | | | |
| ethanethiol | 21 | 7 | 8 | 60 |
| (ppm) | | | | |
| ethyl vinyl | 4 | 2 | 1 | 4 |
| sulfide (ppm) | | | | |
| ethyl sulfide | 8 | 4 | 5 | 9 |
| (ppm) | | | | |

Additional embodiments and modifications within the scope of the claimed invention will be apparent to one of ordinary skill in the art. Accordingly, the scope of the present invention shall be considered in terms of the following claims, and is understood not to be limited to the details of the methods described in the specification.

What is claimed is:

1. A method of purifying an O,O-dialkyl S-[2-(alkylthio)alkyl] phosphorodithioate comprising purging a sample comprising one or more volatiles and the O,O-dialkyl S-[2-(alkylthio)alkyl] phosphorodithioate with a gas.

2. A method according to claim 1 wherein the sample is purged with a gas for a time and at a purge rate sufficient to reduce the level of the volatiles in the sample.

3. A method according to claim 1 wherein the gas is air or an inert gas.

4. A method according to claim 3 wherein the inert gas is nitrogen.

5. A method according to claim 1 wherein the sample is purged with about 25 to about 100 liters per minute of air or nitrogen for about 0.5 to about 6 hours at a temperature of about 20° C. to about 40° C.

6. A method according to claim 1 wherein the sample is purged with about 50 liters per minute of air or nitrogen for about 4 hours at about room temperature.

7. A method according to claim 1 wherein the O,O-dialkyl S-[2-(alkylthio)alkyl] phosphorodithioate has the formula 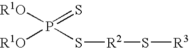
wherein
each R¹ is independently C₁-C₄ alkyl,
R² is C₁-C₄ alkylene, and
R³ is C₁-C₄ alkyl.

8. A method according to claim 7 wherein each R¹ is independently CH₃, C₂H₅, n-C₃H₇, or i-C₃H₇; R² is CH₂ or C₂H₄; and R³ is CH₃ or C₂H₅.

9. A method according to claim 7 wherein each R¹ is C₂H₅, R² is C₂H₄, and R³ is C₂H₅.

10. A method of reducing the level of volatiles in an O,O-dialkyl S-[2-(alkylthio)alkyl] phosphorodithioate having the formula 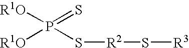
wherein
each R¹ is independently C₁-C₄ alkyl,
R² is C₁-C₄ alkylene, and
R³ is C₁-C₄ alkyl,
comprising subjecting the O,O-dialkyl S-[2-(alkylthio)alkyl] phosphorodithioate to a gas purge.

11. A method according to claim 10 wherein each R² is C₂H₅, R² is C₂H₄, and R³ is C₂H₅.

12. A method according to claim 10 wherein the gas is air or an inert gas.

13. A method according to claim 12 wherein the inert gas is nitrogen.

14. A method of reducing odor in a sample comprising an odorous volatile and an O,O-dialkyl S-[2-(alkylthio)alkyl] phosphorodithioate having the formula 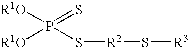
wherein
each R¹ is independently C₁-C₄ alkyl,
R² is C₁-C₄ alkylene, and
R³ is C₁-C₄ alkyl,
comprising subjecting the sample to a gas purge.

15. A method according to claim 14 wherein each R¹ is C₂H₅, R² is C₂H₄, and R³ is C₂H₅.

16. A method according to claim 14 wherein the gas is air or an inert gas.

17. A method according to claim 16 wherein the inert gas is nitrogen.

18. A method according to claim 14 wherein the volatile is sulfur dioxide, chloroethane, ethanethiol, ethyl vinyl sulfide, ethyl sulfide, or a combination thereof.

19. A method according to claim 14 wherein less than 30 ppm of chloroethane remains in the sample after the gas purge.

20. A method according to claim 14 wherein less than 20 ppm of ethanethiol remains in the sample after the purge.
